(19) United States
(12) Patent Application Publication
(10) Pub. No.: US 2002/0100347 A1
(43) Pub. Date: Aug. 1, 2002

(54) Screw driving power tool

(76) Inventors: Gerd Daubinger, Munich (DE); Egon Konigbauer, Eichenau (DE); Lutz Kollner, Munich (DE)

Correspondence Address: DAVID TOREN, ESQ., SIDLEY, AUSTIN, BROWN & WOOD, LLP, 875 THIRD AVE, NEW YORK, NY, 10022, US

(21) Appl. No.: 10/055,659

(22) Filed: Jan. 23, 2002

(30) Foreign Application Priority Data
Jan. 26, 2001 (DE) 101 03 544.6

(51) Int. Cl. B25B 23/151

(52) U.S. Cl. 81/469

(57) ABSTRACT

A screw driving power tool including a housing (1, 31), a handle (2, 32) connected with the housing (1, 31), an actuation switch (3, 33), a screw driving device (18, 48) for receiving a screw-containing magazine (21, 51) and releasably connected with the housing (1, 31), an electric motor (5, 35) located in the housing (1, 31) and having a drive shaft (6, 36); an operating spindle (7, 37) operatively connected with the drive shaft (6, 36) of the electric motor (5, 35), a screw driving working tool (11, 41) for driving screws and connected with the operating spindle (7, 37), and an adjustable torque cut-off device for cutting a torque transmittable to the operating spindle off.

### BACKGROUND OF THE INVENTION

1. Field of the Invention

The present invention relates to a screw driving power tool including a housing, a handle connected with the housing, an actuation switch for actuating the power tool, a screw driving device for receiving a screw-containing magazine and releasably connected with the housing, an electric motor located in the housing and having a drive shaft, an operating spindle, operatively connected with the drive shaft of the electric motor, and a screw driving work tool for driving screws and connected with the operating spindle.

2. Description of the Prior Art

European Publication EP-0058986 discloses a screw driving power tool with a screw driving device for receiving a strip-shaped screw-containing magazine releasably connected with the power tool housing. The screw driving power tool has a housing, a handle connected with the housing, an actuation switch for actuating the power tool, an electric motor located in the housing and having a drive shaft, and an operating spindle located in the housing. The handle adjoins an end of the housing facing in a direction opposite the screw driving direction. The actuation switch is integrated in the handle. The operating spindle, which projects beyond the screw driving direction-side end surface of the housing, is connected with the drive shaft of the electric motor for joint rotation therewith. A screw driving working tool, which engages a to-be-driven-in screw, is connected with the spindle for joint rotation therewith.

In the disclosed power tool, the screw driving direction-side end region of the housing is provided with a cylindrical receiving region having an outer thread. The receiving region serves for receiving and guiding the screw driving device, together with the magazine, with the screws being aligned one after another against the screw driving working tool.

The torque is transmitted to the operating spindle from the drive motor. With the known screw driving power tool, the same screws cannot be driven in and attain the same depth when being driven in constructional components having a different hardness. E.g., when a screw is being driven with the known power tool in a very hard constructional component, it may happen that the transmitted to the operating spindle, torque would not be sufficient to completely drive a screw in, and the screw head would be spaced from the surface of the constructional component the screw is being driven in. When a screw is driven, with the known screw driving power tool, in a rather soft constructional component, the torque could be sufficiently large to easily drive the screw in. However, upon the screw head abutting the surface of the constructional component, a further application of the torque can cause damage of the screw thread or damage the screw head.

Accordingly, an object of the present invention is to provide a screw driving power tool with an easily and rapidly removable screw driving device and which would insure driving screws, which have the same geometry, in constructional components having a different hardness so that, on one hand, the screw head would firmly abut the surface of a construction of component the screw is being driven in, or the free end surface of the screw head and the surface of the constructional component would lie in the same place and, on the other hand, that any damage of the screw caused by an excessive torque is prevented.

Another object of the present invention is to provide a screw driving power tool of the type described above and equipped with a depth stop that would enable the screws to be driven in constructional component, so that the head of a screw would be spaced from the surface of a constructional component by a predetermined distance.

A further object of the present invention is to provide a screw driving power tool of the type described above with which a large number of screws can be driven in a very short time period.

A still further object of the present invention is to provide a screw driving power tool of the type described above and having a reduced weight and smaller overall length in comparison with conventional screw driving power tools including a releasable screw driving device.

### SUMMARY OF THE INVENTION

These and other objects of the present invention, which will become apparent hereinafter, are achieved by providing, in a screw driving power tool with a releasable screw driving device, an adjustable torque cut-off device for cutting a torque transmittable to the operating spindle off.

The use of an adjustable torque cut-off device permits rapidly and simply change a torque value to be applied to a driven-in screw, without a need to undertake any time-consuming changes in the screw driving power tool.

Preferably, the torque cut-off device is formed as an overload clutch which is arranged between the operating spindle and the drive shaft of the drive motor. The over-load clutch can be formed of two rotatable halves, with a plurality of balls provided between the two halves and with a spring stack associated with one of the clutch halves. One of the clutch halves can be rotatably and axial displaceably supported on the operating spindle and be connected with the drive shaft for joint rotation therewith. Another clutch half, which is located adjacent to the screw driving direction-side end region of the housing, is secured on the operating spindle for joint rotation therewith and also with a possibility of an axial displacement relative thereto. Both clutch halves have on their adjacent surfaces a plurality of semi-circular indentations or recesses designed for receiving the balls arranged between the two clutch halves. When a predetermined threshold value of a torque is exceeded, the balls press the other or second clutch half in the screw driving direction against the spring stack until the two clutch halves would rotate relative to each other. The force, with which the spring stack acts, in the direction opposite the screw driving direction on the clutch half associated with the drive shaft, can be adjusted with a circumferentially adjustable adjustment ring. The smaller is the force acting on this clutch half, the smaller is the torque transmitted form the drive shaft to the operating spindle.

A particularly small length of the screw driving power tool, which is equipped with a screw driving device, is achieved when the torque cut-off device is formed as a control electronics which can be arranged in the tool housing. E.g., the control electronics can be arranged in the handle or in the vicinity of the handle.

Preferably, the limiting torque that controls cut-off of the current supply, is adjusted with continuously adjustable electrical resistance connected with the control electronics. Advantageously, the electrical resistance is changed with an adjusting element accessible from outside of the housing. This permits the operator to adjust the transmitted torque quickly and simply with one finger.

The control electronics can be actuated, e.g., by the actuation switch of the power tool. This permits to actuate the control electronics each time the drive motor is switch on.

In order to provide for a uniform penetration depth of screws, advantageously, the operating spindle is displaced, into its operational position, in the directions opposite the screw driving direction against a spring-biasing force. In the operational position of the operating spindle, the clutch, which is arranged between the operating spindle and the drive shaft, connects the drive shaft and the operating spindle for joint rotation with each other. The clutch has two clutch parts provided with claws and a compression spring located between the two clutch parts or halves. In the operational position of the operating spindle, the claws of the two clutch halves engage each other. In the initial position of the operating spindle, the compression spring is in a released condition, and no formlocking connect exists between the two clutch halves.

The first clutch half is connected with the operating spindle for joint rotation therewith, and the second clutch half is rotatably and axially displaceably supported on the operating spindle and is connected with the drive shaft for joint rotation therewith. When the screw driving power tool is pressed against a constructional component, into which the screw is to be driven, the operating spindle, which is supported against a screw that is ready to be driven in is axially displaced in the direction opposite the screw driving direction against a spring-biasing force. Upon being displaced, the operating spindle occupies its operational position in which the claws of the two clutch halves are engaged in each other, providing for a simultaneous rotation of both halves. During the screw driving-in process, the engagement of the claws lasts until the screw driving direction-side end of the screw driving device abuts the surface of the constructional component. With continuation of the screw driving process, the operating spindle is displaced relative to the screw driving device in the screw driving direction until the two halves of the clutch become disengaged.

The desired screw penetration depth can be adjusted with an adjusting screw arranged on the base of the screw driving device and a stop provided on the guide end and with which the adjusting screw cooperates. Instead of using the adjusting screw and the stop, the penetration depth can be adjusted, e.g., by cooperation of the power tool housing and the screw driving device, namely, by adjusting an axial distance therebetween.

The clutch, which connects the operating spindle with the drive shaft, functions only in connection with the depth stop and undergoes very little wear. The clutch halves are connected very rapidly and without noise.

As a current source for the electric motor and the control electronic, an external alternating or direct current source can be used. Also can be used an alternating or direct current battery connected with the power tool. The advantage of using a battery consists in that the power tool, which is equipped with a battery, has the degree of freedom that is larger than that of a power tool connectable with an external power source.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiments, when read with reference to the accompanying drawings.

### BRIEF DESCRIPTION OF THE DRAWINGS

In the Drawings:

FIG. 1 shows a side, partially cross-sectional view of a screw driving power tool according to the present invention with a current limiting device;

FIG. 2 shows a side, partially cross-sectional view of another embodiment of a screw driving power tool according to the present invention with a torque cut-off device; and

FIG. 3 shows, at an increased, in comparison with FIG. 1, scale, a cross-sectional view of a clutch connecting the drive shaft and the operating spindle of the screw driving power tool shown in FIG. 1.

### DETAILED DESCRIPTION OF THE PREFERRED EMBODIMENT

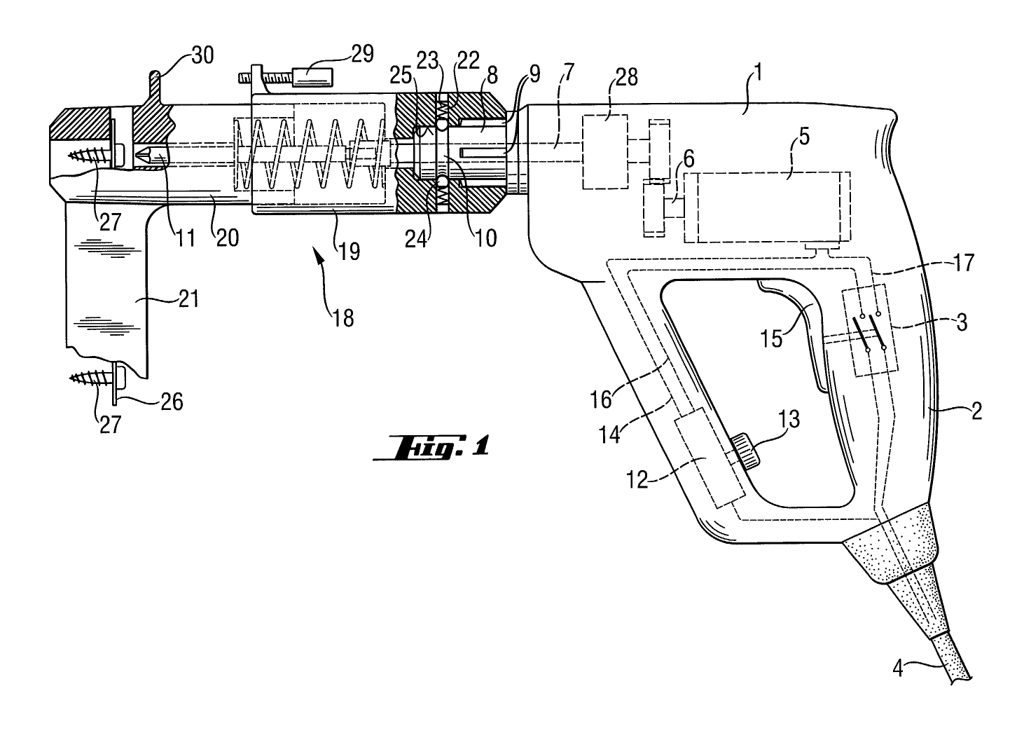

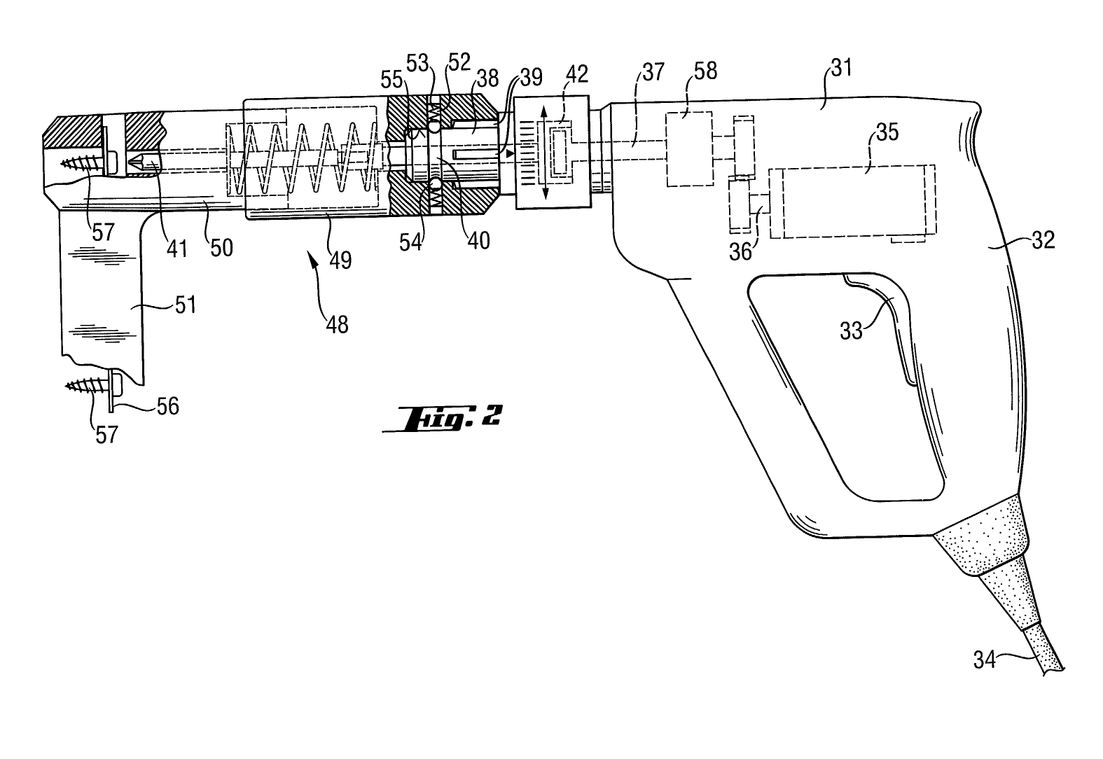

A screw driving power tool according to the present invention, two embodiments of which are shown in FIGS. 1-2, respectively, includes a housing 1, 31, a handle 2, 32 which is arranged sidewise of the housing 1, 31, an actuation switch 3, 33 mounted on the handle 2, 32, and a connection electrical cable 4, 34 extending into the handle 2, 32. The actuation switch 3, which is provided on the handle 2 cooperates with a switch rocker 15 that projects partially from the handle 2. Within the housing 1, 31, there is located an electric motor 5, 35 having a central drive shaft 6, 36. An operating spindle 7, 37, which is likewise located in the housing 1, 31, extends parallel to the drive shaft 6, 36 and is operatively connected with the drive shaft 6, 36 for joint rotation therewith.

The housing 1, 31 has, in it end region facing in the screw-driving direction, a substantially cylindrical receiving region 8, 38 surrounded by a plurality of spaced from each other elongate ribs 9, 29. The rigs 9, 29 extend parallel to the screw driving direction along a portion of the length of the receiving region 8, 38. A circumferential groove 10, 40, which has a substantially semi-circular cross-section, is provided in a region between the ribs 9, 39 and the screw driving direction-side end of the receiving region 8, 38. A screw driving working tool 11, 41 projects beyond the screw driving direction-side end of the receiving region 8, 28 in the screw driving direction. The screw driving working tool 11, 41 is secured in the operating spindle 7, 37 for joint rotation therewith.

The receiving region 8, 38 serves for receiving and guiding a screw driving device 18, 48. The screw driving device has a base 19, 49, a guide member 20, 50, and a magazine 21, 51 that extends sidewise of the guide member 20, 50. The screw driving device 18, 48 has, in its end region facing in the direction opposite to the screw driving direction, a receiving bore 25, 55. The inner geometry of the bore 25, 55 corresponds to that of the receiving region 8, 28 of the housing 1, 31. The ribs 9, 29 are received in corresponding recesses formed in the wall of the receiving bore 25, 55.

The base 19, 49, which adjoins the receiving bore 25, 55, has two bores 22, 52 extending transverse to the screw driving direction. A ball 24, 54, a compression spring 23, 53, and a locking element are located in each of the bores 22, 52. The balls 24, 54 are designed for axially positioning the base 19, 49 with respect to the receiving region 8, 38 of the housing 1, 31. The base 19, 49 has a central through-bore that extends parallel to the screw driving direction. The screw driving working tool 11, 41 extends through the central through-bore of the base 19, 49. The spring-biased balls 24, 54 provide for quick lifting of the screw driving device 18, 38 off the receiving region 8, 38 of the housing 1, 31.

The guide 20, 50 projects partially into the base 19, 29. The guide 20, 50 is displaceable in the direction opposite the screw driving direction relative to the base 19, 29 against a spring-biasing force. A magazine 21, 51 projects sidewise of the guide 19, 49. The magazine 21, 51 has a transporting channel for receiving and guiding arranged one after another, screws 27, 57. The magazine 21, 51 is formed of the screws 27, 57 and a screw-supporting flat strip 26, 56 which can be formed, e.g., of a plastic material.

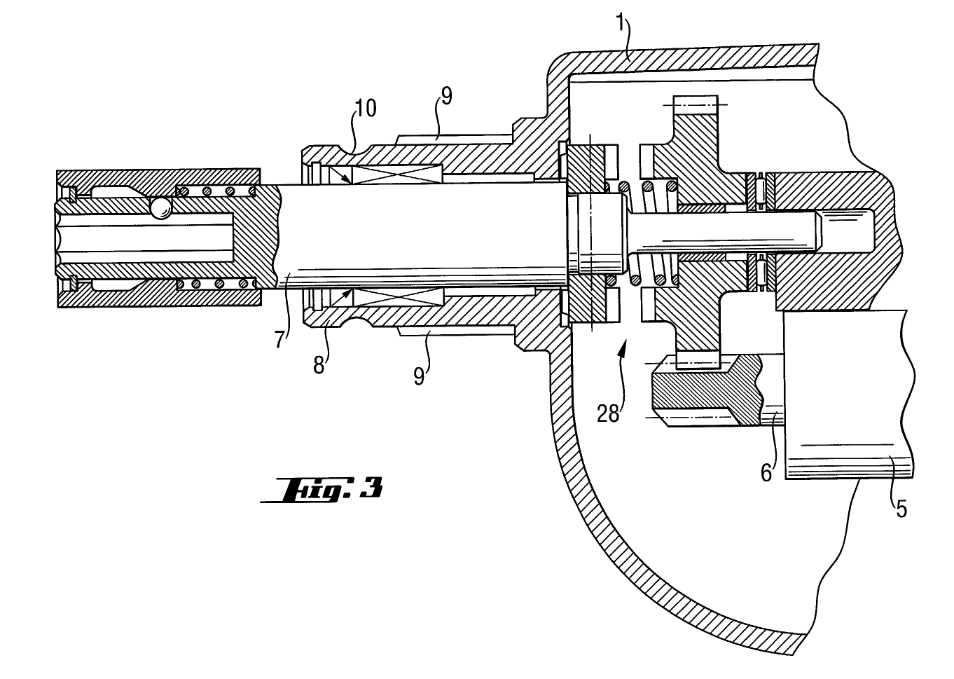

In order to provide for a uniform perpetration depth of the screws 27, 57, the operating spindle 7, 37 can be arranged in the housing 1, 31 with a possibility of a limited displacement in the screw driving direction. The operating spindle 7 cooperates, as it is particularly shown in FIG. 3, with a clutch 28, 58 which is arranged between the operating spindle 7, 27 and the drive shaft 6, 36 and which is provided with claws. A first clutch half is connected with the operating spindle 7, 37 for joint rotation therewith but without a possibility of rotation relative thereto, and the second clutch half is connected with the drive shaft 6, 36 for joint rotation therewith. When the screw driving power tool is pressed against a constructional component, into which a screw 27 is to be driven, the operating spindle 7, 37, which is supported against a screw 27, 57, which is ready to be driven in, is axially displaced in the direction opposite the screw driving direction against a spring-biasing force. Upon being displaced, the operating spindle occupies its operational position in which the claws of the two clutch halves are engaged in each other, providing for a simultaneous rotation of both halves. During the screw driving-in process, the engagement of the claws lasts until the screw driving device abuts the surface of the constructional component. With continuation of the screw driving process, the operating spindle 7, 37 is displaced relative to the screw driving device 18, 38 in the screw driving direction until the two halves of the clutch 28, 58 become disengaged.

As shown in FIG. 1, the screw penetration depth can be adjusted with an adjusting screw 29 arranged on base 19 of the screw driving device 18 and a stop 30 provided on the guide 20 and with which the adjusting screw 29 cooperates. Instead of using the adjusting screw 29 and the stop 30, the penetration depth can be adjusted, e.g., by cooperation of the power tool housing and the screw driving device, namely, by adjusting an exial distance therebetween.

The screw driving power tool, which is shown in FIG. 1, has a torque cut-off device which is formed as control electronics 12 that limits the current fed to the electric motor 5. The limiting torque, which cuts-off the current supply, is adjusted with a continuously adjustable resistance connected with the control electronic 12. The resistance cooperates with an adjusting element 13 which is provided on the handle 2. The control electronics 12 is connected with the electric motor 5 by a connection conductor 14. If the control electronics 12 is actuated by the actuation switch 3, it is connected with the switch by a connection conductor 16 and with the elective motor 5 by a connection conductor 17.

The screw driving power tool, which is shown in FIG. 2, is provided with a mechanical torque cut-off device 42, not shown in detail, which is formed as an overload clutch.

Though the present invention was shown and described with references to the preferred embodiments such are merely illustrative of the present invention and are not to be construed as a limitation thereof, and various modifications to the present invention will be apparent to those skilled in the art. It is, therefore, not intended that the present invention be limited to the disclosed embodiments or details thereof, and the present invention includes all of variations and/or alternative embodiments within the spirit and scope of the present invention as defined by the appended claims.

What is claimed is:

1. A screw driving power tool, comprising a housing (1, 31); a handle (2, 32) connected with the housing (1, 31); an actuation switch (3, 33) for actuating the power tool; a screw driving device (18, 48) for receiving a screw-containing magazine (21, 51) and releasably connected with the housing (1, 21); an electric motor (5, 35) located in the housing (1, 31) and having a drive shaft (6, 36); an operating spindle (7, 37) operatively connected with the drive shaft (6, 36) of the electric motor (5, 35); a screw driving working tool (11, 41) for driving screws and connected with the operating spindle (7, 37); and an adjustable torque cut-off device for cutting a torque transmittable to the operating spindle off.

2. A screw driving power tool according to claim 1, wherein the torque cut-off device is formed as a mechanical overload clutch (42) arranged between the operating spindle (7, 37) and the drive shaft (6, 36) of the electric motor (5, 35).

3. A screw driving power tool according to claim 1, wherein the torque cut-off device is formed as a control electronics (12) for cutting off a current supply upon the torque reaching a predetermined threshold.

4. A screw driving power tool according to claim 3, wherein the control electronic is arranged in the handle (2).

5. A screw driving power tool according to claim 3, further comprising a continuously adjustable electrical resistance connected with the control electronics for establishing the torque threshold at which the current supply is cut off.

6. A screw driving power tool according to claim 5, further comprising an adjusting element (13) connected with the electrical resistance for establishing resistance corresponding to a predetermined torque threshold and located outside of the housing (1).

7. A screw driving power tool according to claim 3, wherein the control electronics (12) is connected with the actuation switch (3) for being actuated by same.

8. A screw driving power tool according to claim 1, further comprising a clutch (28, 58) arranged between the operating spindle (7, 37) and the drive shaft (6, 36) for connecting the operating spindle with the drive shaft for joint rotation therewith, the operating spindle being displaceable in a direction opposite the screw driving direction against a spring-biasing force into an operational position thereof in which it becomes connected with the drive shaft for joint rotation therewith.
